(19) United States
(12) Patent Application Publication
(10) Pub. No.: US 2002/0073013 A1
(43) Pub. Date: Jun. 13, 2002

(54) Business model for performing bandwidth trading

(76) Inventor: Paul Haddad, Alpharetta, GA (US)

Correspondence Address: Gregory Scott Smith, Esq., Troutman Sanders LLP, Docketing Clerk - 46th Floor, 600 Peachtree Street, Suite 5200, Atlanta, GA, 30303, US

(21) Appl. No.: 09/737,275

(22) Filed: Dec. 12, 2000

Related U.S. Application Data
(60) Provisional application No. 60/214,096, filed on Jun. 26, 2000.
(60) Provisional application No. 60/214,144, filed on Jun. 26, 2000.

(51) Int. Cl. G06F 17/60

(52) U.S. Cl. 705/37

(57) ABSTRACT

A three sectored business model that facilitates the trading of bandwidth as a commodity. A first sector (100) includes resource entities (102) that generate the resource or commodity to be traded—bandwidth. Another sector (140) includes bandwidth enabling entities (142) that neutrally provide a pool of bandwidth that can be obtained from a variety of resource entities (102) in a competitive manner. The last sector (120) includes trading entities (122) that interface with consumer entities or traders (160) and facilitate the trading of the bandwidth based on the availability of the bandwidth from one or more bandwidth enabling companies (142).

### RELATED APPLICATIONS

This application is related to U.S. Provisional Application Serial No. 60/214,096 ______, entitled “A BANDWIDTH TRADING ENGINE”, filed on Jun. 26, 2000 and U.S. patent application Ser. No. ______, entitled “A BANDWIDTH TRADING ENGINE” filed on Nov. ______,2000. This application claims the benefit of the filing date of U.S. Provisional Application Serial No. 60,214,144 filed on Jun. 26, 2000.

### TECHNICAL FIELD

This invention relates to the field of telecommunications and, more specifically, to a business model enabling the trading of bandwidth within a telecommunications system, as a freely traded commodity.

### BACKGROUND

As telecommunication technology continues to develop and allow the establishment of telecommunication systems that are faster, more efficient, and more reliable, a problem that is facing the world is how to dynamically allocate the available bandwidth to maximize the use thereof. In addition, in today's environment, once a carrier establishes connectivity to a site, in essence the carrier obtains a monopoly with respect to that site. This monopoly is established regardless of whether the site is a building, a hub, a point of presence “POP”, or any other form of consumer entity. The monopoly is based on the following scenario. A consumer entity must spend a large amount of money to obtain connectivity to a carrier's facilities. This cost covers activities such as digging and laying cable, extending the cable to the consumer entity, and connecting and integrating the consumer entity into the telecommunications system. Once these tasks have been accomplished, to switch to a more competitive carrier, the consumer entity must again expend considerable cost to obtain connectivity with the more competitive carrier. Once connectivity with the more competitive carrier has been obtained, the consumer entity once again is in the same situation—the more competitive carrier now has a monopoly on the consumer entity's telecommunications business. This is especially true when the consumer entity has signed a long-term contract with the carrier. Thus, there is a need in the art to provide the ability to meet the bandwidth requirements of a person or entity in a competitive manner—in a manner similar to meeting the requirements and needs for other commodities. There is also a need in the art to enable short-term contracts for bandwidth to be obtained by a consumer entity. This need has given rise to the concept of bandwidth trading.

The implementation of bandwidth trading has proven to be a difficult hurdle to clear. There are three basic entities, or classes of entities, involved in the bandwidth trading business: trading entities, bandwidth buyer and seller entities (resource entities), and exchange or minute selling entities. There is a vast amount of confusion in the market place on how these entities plan on conducting business. Trading entities have traditionally traded commodities on public exchanges or over the counter. These commodities include items such as pork bellies, tobacco, coffee, crude oil, or the like. Trading entities have been trading such commodities for years and are very familiar with the procedures necessary to successfully trade such commodities. In addressing the bandwidth trading aspect of the business, some trading entities plan on building their own networks to create the bandwidth commodity, and then trade the commodity they have just created. However, the traditional trading entities have little to no experience in the world of telecommunications, yet alone, bandwidth trading. Therefore, the anticipated success of this approach is, at the very most, skeptical. In order to ensure a successful bandwidth trading industry, it is necessary to efficiently perform the following tasks:

(a) locate bandwidth to be traded;

(b) exchange related data;

(c) accept a request for a bandwidth trade;

(d) execute the trade and deliver or physically connect the traded band;

(e) manage the traded bandwidth;

(f) provide customer service in support of the traded bandwidth; and

(g) ensure financial clearance among all participants.

The resource entities include but are not necessarily limited to carrier companies and/or service providers. Today, some resource entities are planning on simply trading the commodity of bandwidth that they are currently creating and operating. However, although these resource entities are very aware of the telecommunications business, they are just beginning to learn the complexities of the operation and procedures of the commodities trading business. Thus, it may be difficult for the resource entities to setup and operate a successful trading system.

The exchange entities are stuck in the middle of both confusions. Today, the exchange entities primarily focus on selling minutes. Selling minutes is a substantially different concept from trading bandwidth. Thus, there is a need in the art for a method to trade bandwidth as a commodity, that enables each of the participants to operate in their most optimal fashion, and provides a reasonable solution for trading bandwidth.

There are some companies that are currently attempting to operate in all three of the above-described classes by trading, selling minutes and owning networks. This type of approach will operate to stifle the emergence of true bandwidth trading and will result, in reality, to simply implement the above-described monopoly model.

Thus, there is a need in the art for a business model that will efficiently allow for bandwidth trading. The business model must facilitate the creation of a true bandwidth trading industry within a neutral and flexible environment. Companies adopting such a business model will most typically operate as one of the above-described classes of entities. The business model allows the adopting entities to deal with other entities, establish business deals, and transact over each other's sites or facilities.

### SUMMARY OF THE INVENTION

The present invention solves the above-described problems by providing a business model for trading bandwidth as a commodity. Generally described, the present invention defines three business sectors: resource entities, bandwidth enabling entities, and trading entities. The resource entities create the bandwidth commodity. The bandwidth enabling entities operate as neutral parties and obtain connectivity to the facilities of one or more resource entities. The trading entities serve as an interface to a consumer entity or trader and allow for the purchase, selling, reselling or otherwise trading of the bandwidth commodity. Thus, utilizing the business model of the present invention, bandwidth can be freely traded as a commodity.

More specifically, the bandwidth trading business model enables a trader, operating in the interest on one or more end points, to trade a certain amount of bandwidth for a certain period of time. An end point be any of a variety of elements including, but not limited to, a private branch exchange, a hub, a point of presence “POP”, a central office switch, a pooling point, or any other of a variety of system or consumer elements. The traded bandwidth is a real quantity of bandwidth that may be utilized to communicate between two end points of a telecommunications system during a specific time period. The bandwidth enabling entities establish multiple pooling points that are interconnected with end points within a telecommunications network. A pooling point is an element that operates to provide connectivity between (a) one or more endpoints and the facilities of one or more resource entities, (b) one or more pooling points and the facilities of one or more resource entities or end points, or (c) multiple resource entities. Thus, the pooling points interface with the facilities provided by resource entities, each of the resource entities providing bandwidth capacity between pairs of the pooling points and/or between end points and pooling points. The resource entities may include companies that provide world wide or nation wide networks, as well as smaller, more local telecommunication networks. The bandwidth enabling entities negotiate and enter into agreements with the resource entities. These agreements relate to the provision and cost of the bandwidth capacity between pooling points and between pooling points and end points. A trading entity provides an interface to the consumer entity or trader whereby the consumer entity may request a trade of a certain amount of bandwidth capacity between two end points, an end point and a pooling point, or two pooling points.

In operation, a trader approaches a trading entity with a request to trade a specific bandwidth commodity. This trade may encompass a specific quality of service, time frame, data rate, or the like. In response to such request, the trading entity executes the trade either over a specific bandwidth enabling entity's pooling point or over the pooling points of one or more bandwidth enabling entities or over the resource entity's networks directly. The underlying operations of the trading entity are transparent to the trader. As an example, a trader may request a purchase of a particular amount of bandwidth to be active at a particular time for a particular duration. The trader does not need to be aware of who is providing or obtaining the bandwidth or what other entities are involved in the trade. All that the trader is concerned about is (a) obtaining the desired bandwidth for the desired price and quality of service, and (b) if the trader's intention is to actually utilize the bandwidth, then at the requested time, the connections are established to provide connectivity with the requested bandwidth capacity. The reader should understand that as a commodity, the trader may have no intention of actually utilizing the traded bandwidth. Thus, if the trader so chooses, the bandwidth capacity, or any unused portion there of may be traded through a trading entity prior to the total consumption of the bandwidth. In addition, the trader may sub-divide the bandwidth and trade each portion of the divided bandwidth separately. The present invention provides a model that enables a bandwidth trading industry that can efficiently perform the tasks of:

(a) locating bandwidth to be traded;

(b) exchanging related data;

(c) accepting a request for a bandwidth trade;

(d) executing the trade and delivering or physically connecting the traded band;

(e) managing the traded bandwidth;

(f) providing customer service in support of the traded bandwidth; and

(g) ensuring financial clearance among all participants.

These and other aspects, feature, and advantages of the present invention will be more clearly understood and appreciated from a review of the following detailed description of the present invention and possible embodiments thereof, and by reference to the appended drawings and claims.

### BRIEF DESCRIPTION OF THE DRAWINGS

FIG. 1 is a conceptual diagram of an exemplary embodiment of the bandwidth trading business model of the present invention.

FIG. 2 is a system diagram of a conceptual network suitable for an exemplary embodiment of the bandwidth trading business model.

FIG. 3 is a system diagram of a more complex conceptual network suitable for an exemplary embodiment of the bandwidth trading business model.

### DETAILED DESCRIPTION OF THE INVENTION

The present invention identifies a business model to facilitate bandwidth trading within the telecommunications industry. Based on the business models in existence today, the long-run financial viability of these business models, and the market sizes and technologies associated with bandwidth resources, the most profitable and efficient model to implement bandwidth trading is to divide the market into three sectors and confine the operation of entities within one of these three sectors. The three sectors include resource entities, bandwidth enabling entities, and bandwidth trading entities.

The carriers are the natural resource owners and producers of the bandwidth commodity. In the realm of bandwidth trading, the natural resource to be traded is the networks or, more specifically, the bandwidth availability of the network. Every transmission medium can be defined by the amount of bandwidth that can be passed through the medium. Bandwidth is the measure of how much information can pass through the medium. The bandwidth of a particular transmission medium can often times be subdivided and utilized among various entities. Those skilled in the art will understand that bandwidth within a transmission medium can be divided using a variety of techniques such as frequency translation, time division multiplexing, code division multiplexing, channelization, or the like. Regardless of the technique used, measurable amounts of bandwidth of a transmission medium can be allocated and reserved for a particular entity. Thus, for purposes of this application, the term bandwidth is used to broadly refer to any measurable allocation of capacity on any type of traffic carrying medium.

The bandwidth enabling entities operate as the pipeline and shipping player within the bandwidth trading business model. The enabling entities (a) establish, own, and/or operate pooling points which operate to connect the facilities of consumer entities to the network facilities of a resource entity at the physical level and (b) make or facilitate the trade or exchange of bandwidth.

The bandwidth trading entities are the pure traders within the business model. The bandwidth trading entities operate by taking position, hedging risks, managing the commodity, or the like—operations typical to most commodity trading companies. The business model of the present invention allows for flexible and generic bandwidth trading. Through an adaptation of this business model, any trading entity can trade on any pooling point, where capacity and bandwidth are available, without regard to which carrier owns or operates the network.

As an example, trading entity A may sign a deal with bandwidth enabling entity B to trade bandwidth over bandwidth enabling entity B's pooling points in New York, Los Angeles, and Atlanta. Additionally, bandwidth enabling entity B may sign a deal with resource entities C and D whereby resource entities C and D connect their networks to the pooling sites of bandwidth enabling entity B located in New York and Los Angeles. Company B also may also sign a deal with resource entities C and E whereby resource entities C and E are connect their networks to the pooling site of bandwidth enabling entity B located in Atlanta. Thus, any party at the trading entity A is able to work with a variety of bandwidth enabling companies who, in turn can each work with a variety of carrier companies. Thus, neutrality is preserved among all the participants—a business model that directly contrasts with the monopolistic model that exist today.

Turning now to the figures in which like numerals represent like elements throughout the several views, exemplary embodiments of the present invention are described.

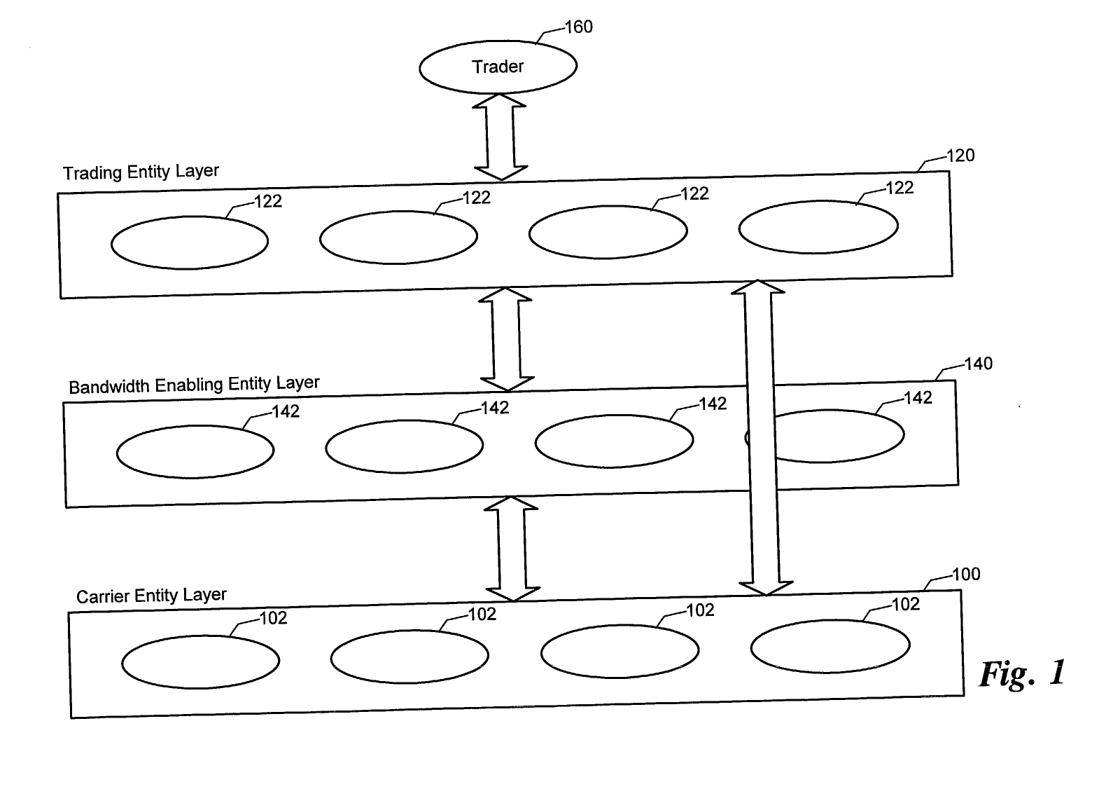

FIG. 1 is a conceptual diagram of an exemplary embodiment of the bandwidth trading business model of the present invention. The relationship between each of the three sectors is shown as three layers within the business model. Each of the entities operating in a layer performs a substantially different task than the entities in the other layers. The lower layer is the resource entity layer 100. The resource entity layer includes one or more resource entities 102 that operate within the resource layer 100 of the business model. In one embodiment of the present invention, the resource entities 102 build, own and operate telecommunications networks—the source of a bandwidth commodity—but may actually be any of a variety of entities that sell bandwidth. As previously described, the resource entities 102 may own and operate world wide, national, or localized networks. The networks may be traditional, fiber optic, cable, a hybrid of fiber optic and cable “HFC”, wireless, satellite, or any of a variety of other network types. The upper layer is the bandwidth trading entity layer 120. Traditional trading entities 122 reside at this layer of the business model. The typical trading entities 122 that currently trade energy, utilities, or other commodities, will assume the role of trading bandwidth as an additional commodity within their portfolio of commodities. In addition, some trading companies may be totally dedicated to trading bandwidth. The middle layer is the bandwidth enabling entity layer 140. Bandwidth enabling entities 142 reside at this layer of the business model. The key aspect of the bandwidth enabling entities 142 is the maintenance of neutrality. Neutrality of the bandwidth enabling entities 142 enables the free trading of the bandwidth in a competitive, non-monopolistic fashion. The structure and operation of the business model of the present invention uniquely establishes the ability for neutrality.

In operation, the resource entities 102 produce the bandwidth commodity. The resource entities are familiar with telecommunications technology and communication networks and, to be successful, it is necessary for the resource entities to be experts in providing reliably, easily accessible, credible, robust and cost effective services. Thus, as a source for bandwidth commodity, the resource entities are particularly well suited.

The bandwidth enabling entities 142 perform several functions within the business model. One such function is building or establishing pooling points and negotiating business agreements with various resource entities 102 under which the resource entities 102 connect to the pooling points. The business agreements identify a price, or a pricing structure, at which the bandwidth enabling entities 142 can obtain the bandwidth from the resource entities. Another function of the bandwidth enabling entities 142 is to provide connectivity to the facilities of a resource entity 102, another pooling point, or an end point.

The trading entities 122, serve as the interface and enabling agent for the consumer entity or trader 160 to trade bandwidth. A trader 160 will approach a trading entity 122 with a request to trade a portion of bandwidth. Based on the bandwidth availability across various pooling points, the business relationship between the trading company 122 and the bandwidth enabling entity 142, the trading entity 122 can execute the requested trade. In addition, the trading entity 122 may interface directly to the a resource entity 102 in order to execute the trade. The executed trade can be in the form of a commit or an open trade. In a commit trade, the bandwidth enabling entities 142 will allocate the traded bandwidth and reserve the resources necessary to provide the bandwidth. For an open trade, the bandwidth enabling companies 142 do not commit resources under the expectation that the bandwidth will again be traded prior to the time that the bandwidth is to be consumed.

Thus, the business model illustrated in FIG. 1 allows a trader 160 to approach one or more trading entities 122 to fulfill a trade. If the trader 160 elects a particular trading entity 122, the trader will still have the benefit of the trading company dealing with multiple bandwidth enabling entities, which in turn may deal with multiple resource entities 102. This business model advantageously enables the trader 160 to trade bandwidth in a competitive and neutral manner.

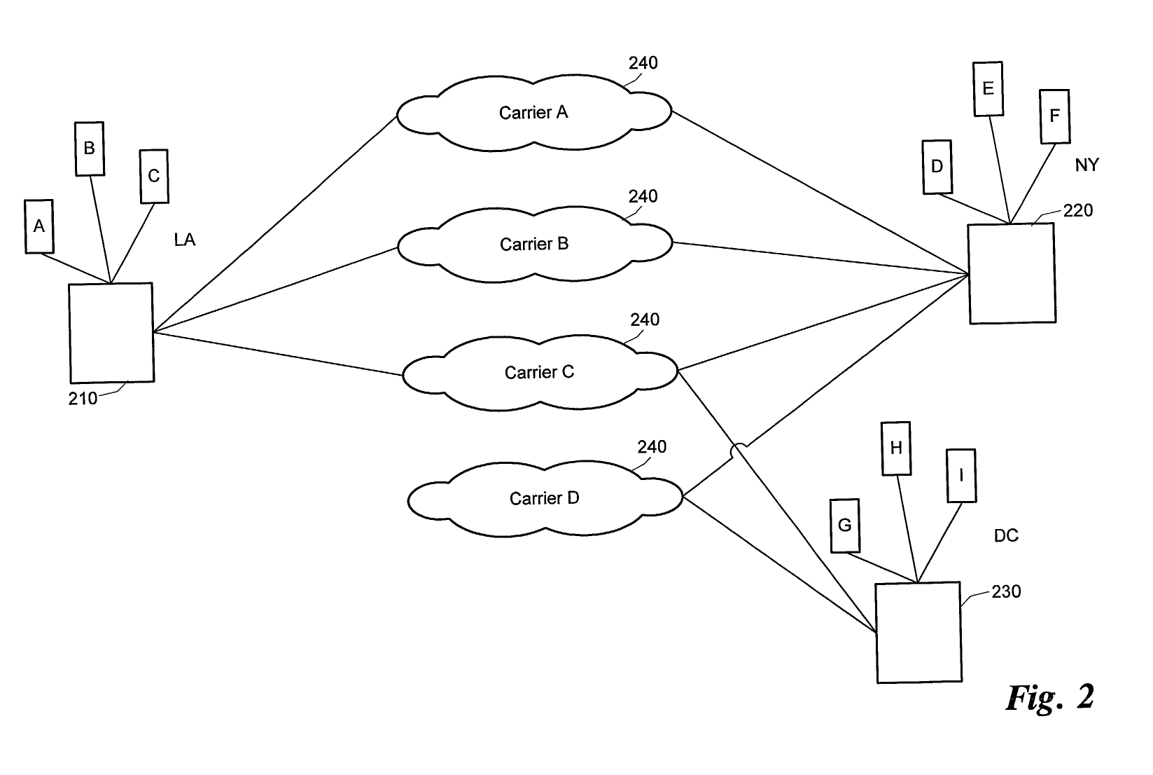

FIG. 2 is a system diagram of a conceptual network suitable for an exemplary embodiment of the bandwidth trading business model. Bandwidth enabling entities 142 establish pooling points at various locations. Each pooling point is illustrated as a compression point between the facilities 240 of one or more resource entities 102 and one or more end points 250. For instance, a pooling point 210 located in Los Angeles, Calif. provides connectivity to end points A, B and C 250. A pooling point 220 located in New York City, New York provides connectivity to end points D, E and F 250. A pooling point 230 located in Washington DC provides connectivity to end points G, H and I 250. In the most simplistic model, assume that a single bandwidth enabling entity 142 owns all three of the illustrated pooling points 210, 220 and 230.

The bandwidth enabling entity 142 has previously negotiated and closed a deal with Carrier A, Carrier B, and Carrier C for the Los Angeles pooling point 210, Carrier A, Carrier B, Carrier C and Carrier D for the New York City pooling point 220, and Carrier C and Carrier D for the Washington DC pooling point 230. Thus, connectivity exists between: (a) the LA pooling point 210 and the facilities 240 of Carrier A, B, and C; (b) the NY based pooling point 220 and the facilities 240 of Carrier A, B, C, and D; and (a) the DC based pooling point and the facilities 240 of Carrier C and D. The bandwidth enabling entity 142 establishes relationships with one or more trading entities 122 and provides such connectivity information to such trading entity 122.

As an example, a consumer entity or trader located in Los Angeles, a technology company, anticipates a need for additional bandwidth between their New York City office and their Los Angeles design center for a two month period during a project development cycle. The trader approaches the trading entity 122 and describes the specific parameters or bandwidth requirements. The parameters may include a desired price, a duration of use, a minimum capacity, minimum turnaround time for meeting the demand, or the like. Based on this request, the trading entity 122 will look for available bandwidth on specific pooling points. The trading entity 122 may then ask for a commit or a non-commit trade, based on the needs of the trader, from one or more bandwidth enabling entities 142 to meet this request. The trading entity 122 will then present to the trader, one or more of the availability options based on one or more bandwidth enabling entities 142. In the alternative, the trading entity 122 can initiate a bidding process to meet the request of the trader. In this embodiment, the bandwidth sellers or resource entities connected to a pooling point of interest can bid for the provision of the service based on the specific request of the trader. It should be understood that trading entities 122 as well as bandwidth enabling companies 142 can participate in this bidding process. In fact, a trader may even participate in the bidding process if the trader has bandwidth to trade or a need for bandwidth. Regardless of the technique, the trader then, in this example, has the opportunity to select from various options. The ability to choose from multiple options is enabled by the business model of the present invention. Due to the fact that multiple carriers may be connected to the pooling points, the bandwidth enabling entities 142, operate as neutral agents for the provision of the bandwidth.

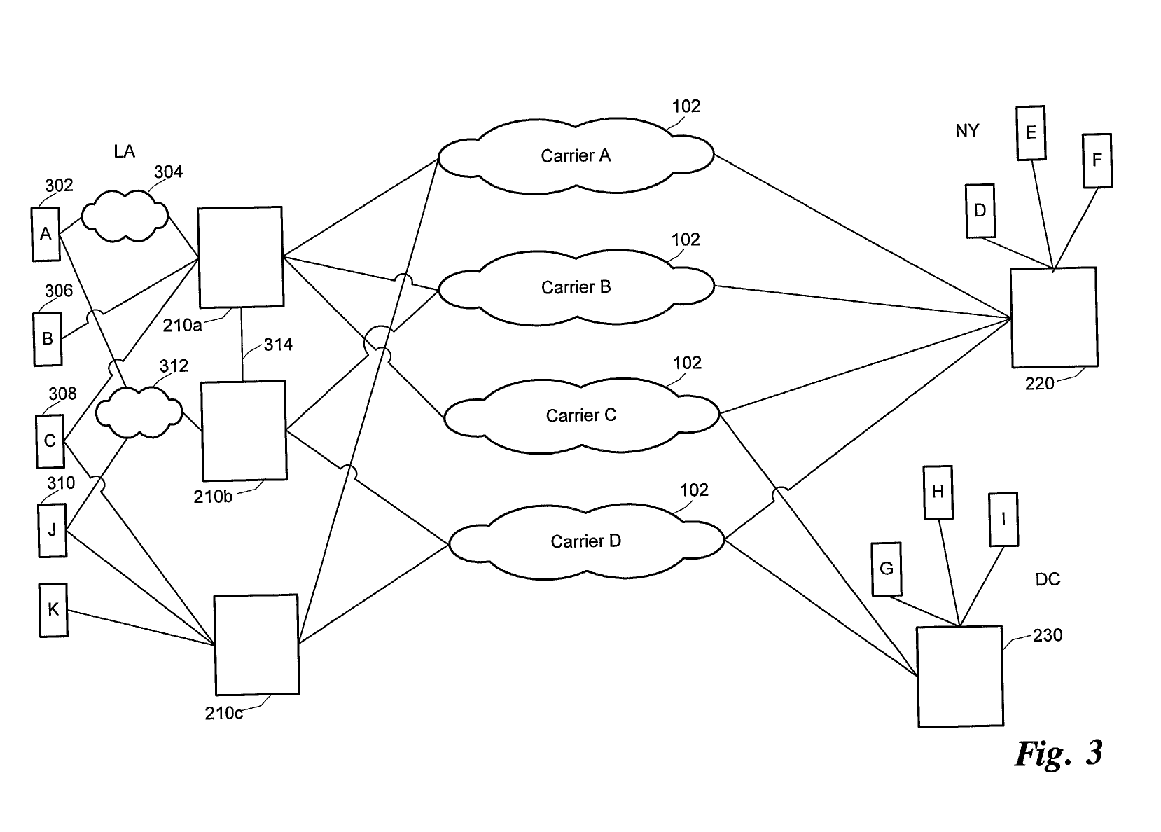

FIG. 3 is a system diagram of a more complex conceptual network suitable for an exemplary embodiment of the bandwidth trading business model. In this figure, multiple bandwidth enabling entities 142 are shown as servicing the same geographical area and even the same end points. Each of the bandwidth enabling entities 142 negotiate and close deals with the various resource entities 102 in order to establish connectivity between two pooling points or a pooling point and an end point. Several configurations and relationships may exist. For instance, one pooling point 210a in LA may connect to one end point 302 through a local carrier 304 and to other end points 306 and 308 directly. Another pooling point 210b in LA may connect to a local carrier 312 which in turn may provide connectivity to one or more end points 302, 310. Yet in another configuration, one pooling point 210a may be directly connected to another pooling point 210b. Thus, a vast array of agreements between resource entities 102, bandwidth enabling entities 142 and even consumer entities owning, operating or controlling end points, can be established to obtain connectivity within a telecommunications network. An advantage of the present invention is that the bandwidth enabling entities 142 can be completely neutral and impartial regarding which resource entities are involved within any one specific bandwidth trade. This beneficially provides greater flexibility and more options to the consumer entities or traders.

Advantageously, the present invention also enables a bandwidth trade to be fulfilled using the facilities of a variety of resource entities 102 and bandwidth trading entities 142. For instance, assume that pooling point 210a and 210b are owned by different bandwidth enabling entities 142. One of the options presented to a trader 160 from the trading entity 122 may include a connection consisting of the link through local carrier 304 to a first pooling point 210a, a link to a second pooling point 210c through the facilities of Carrier A, and a direct link to end point J 310. This option involves facilities of two resource entities 122 and two bandwidth enabling entities 142 (pooling points 210a and 210c). Thus, each segment of a communications path between two end points can be the result of independent agreements between a bandwidth enabling entity 142 and a resource entity 122, thereby increasing the flexibility available to the trader.

Once a trader completes a bandwidth trade through a trading entity 122 or, in the bidding model, a bandwidth trading entity 122 or a bandwidth enabling entity 142, the trading company 122 will notify the bandwidth enabling company 142 through a data exchange system, if necessary, which in turn may provide notice to the resource entity 102 regarding this transaction. This transaction is automatically executed at the physical layer by the bandwidth enabling company 142. The trader receives physical bandwidth for the duration of the negotiated time frame. At the appropriate time, the required bandwidth is switched in and made available to the trader and then disconnected at the conclusion of the time frame.

An advantage of the present invention is that the bandwidth, similar to any other commodity, can be traded multiple times before it is fully expended. For instance, in the previous example, if the trader experiences a delay in its project and its need for the additional bandwidth is likewise delayed (e.g. for a period of several months), the trader can trade the bandwidth through the trading company 122. If the market price of the bandwidth, based on the supply and demand, has increased, then the trader may even realize a profit in selling the bandwidth. On the other hand, even if the market price of the bandwidth has dropped, from a business perspective, it may make since to sell the bandwidth at a loss rather than paying full price when it will not even be utilized, and then repurchase additional bandwidth to coincide with the actual need.

Another advantage of the business model of the present invention is that bandwidth can be traded as a true commodity. As the business captured by trading entities increases, the willingness of carriers to negotiate and close deals with the bandwidth enabling entities will also increase. The cost for the bandwidth will then be dictated, to some extents, by the principles of supply and demand. On one hand, this may have the affect of lowering the cost of bandwidth when the demand is low and the supply is high. However, on the other hand, this business model will open the door for carriers to sell bandwidth at a bargain price, where as without the use of this business model, the bandwidth may have gone unused.

Thus, the present invention provides a three sectored business model that facilitates the trading of bandwidth as a commodity. One sector includes resource entities that generate the resource or commodity to be traded—bandwidth. Another sector includes bandwidth enabling entities that neutrally provide a pool of bandwidth that can be obtained from a variety of resource entities in a competitive manner. The last sector includes trading companies that interface with consumer entities or traders and facilitate the trading of the bandwidth based on the availability of the bandwidth from one or more bandwidth enabling companies.

What is claimed is:

1. A bandwidth-trading business model for enabling an entity to trade bandwidth as a commodity, the bandwidth representing a certain amount of communication capacity for a certain period of time to be utilized to communicate between a first end point and a second end point, the business model comprising the components of:
a plurality of bandwidth selling entities providing bandwidth capacity between the first end point and the second end point;
a bandwidth enabling entity having an agreement with at least one of the plurality of bandwidth selling entities, the agreement relating to the provision and cost of bandwidth capacity between the first end point and the second end point; and
a trading entity providing an interface to a trader whereby the trader may request a trade of bandwidth capacity between the first end point and the second end point and, in response to such trade request, the trading entity can cause the execution of the trade based on the agreements between the bandwidth enabling entity and the at least one of the plurality of bandwidth selling entities.

2. The bandwidth-trading business model of claim 1, wherein the first end point is a pooling point that is controlled by the bandwidth enabling entity.

3. The bandwidth-trading business model of claim 1, wherein the first end point and the second end point are a pooling points that are controlled by the bandwidth enabling entity.

4. The bandwidth-trading business model of claim 1, wherein the trade request is for a purchase of bandwidth for a specific period of time.

5. The bandwidth-trading business model of claim 1, wherein the trade request is for a sell of bandwidth for a specific period of time.

6. A method for trading bandwidth as a commodity, the method comprising the steps of:
establishing a plurality of pooling points, each pooling point being communicatively coupled to one or more of a plurality of end points and the facilities of one or more bandwidth selling entities, and each pooling point being controlled by a bandwidth enabling entity;
for each pooling point, the bandwidth enabling entity negotiating a connection agreement with one or more bandwidth selling entities, the connection agreement identifying a price associated with bandwidth capacity between the pooling point and one of the plurality of end points;
receiving a bandwidth trade request from a trader, the bandwidth trade request being received by a trading entity and identifying a bandwidth capacity between a first end point and a second end point of the plurality of end points; and
in response to receiving the bandwidth trade request, the trading entity executing the trade based on the connection agreements existing between the bandwidth enabling entities and the bandwidth selling entities.

7. The method of claim 6, wherein the trade request is a purchase request for a specific bandwidth over a particular period of time and further comprising the step of providing connectivity between the first end point and the second end point in accordance with the purchase request.

8. The method of claim 7, wherein prior to the end of the particular period of time, receiving a bandwidth sell request, the bandwidth sell request being received by a trading entity, the trading entity, in response to receiving the bandwidth sell request, executing the bandwidth sell request based on the connection agreements existing between the bandwidth enabling entities and the bandwidth selling entities.

9. An exchange company, operating as an interface between a plurality of carrier companies and a plurality of trading companies, the exchange company facilitating a business method of bandwidth trading by being operative to:
establish a plurality of pooling points, each pooling point interfacing with one or more end points and with one or more system operator facilities and being established by an exchange company;
obtain operating agreements with the one or more system operator facilities, the operating agreements identifying the cost of bandwidth charged to the exchange company; and
obtain relationships with one or more trading companies, the relationships with the one or more trading companies allowing the exchange company to provide executable offers for bandwidth capacity for certain periods of time in response to request received from the trading companies.

10. The exchange company of claim 5, wherein the request received from the trading company identifies a certain capacity, a required availability time, a first end point and a second end point and prior to the required utilization time, being operative to provide connectivity between the first end point and the second end point, the connectivity providing the requested bandwidth capacity.

11. A bandwidth-trading business model for enabling a trader to purchase a certain amount of bandwidth for a certain period of time to be utilized to communicate between a first end point and a second end point, the business model comprising the components of:
a plurality of bandwidth selling entities providing bandwidth capacity between the first end point and the second end point;
a bandwidth enabling entity having an agreement with at least one of the plurality of bandwidth selling entities, the agreement relating to the provision and cost of bandwidth capacity between the first end point and the second end point;
a trading company providing an interface to the trading entity whereby the trading entity may request a trade of bandwidth capacity between the first end point and the second end point and, in response to such trade request, execute the trade based on the agreements between the bandwidth enabling entity and the at least one of the plurality of bandwidth selling entities.

12. A business model for trading commodities comprising:
a resource entity, the resource entity being a provider of the commodity; a trading entity; and
an enabling entity, the enabling entity accumulating commodities from the resource entity and providing a neutral entity from which the trading entity can fulfill a trade request from a trader.

13. The business model of claim 12, wherein the resource entity comprises a plurality of resource providers and the enabling entity can negotiate for the purchase of commodities from one or more of the resource providers.

14. The business model of claim 13, wherein the trading entity can fulfill the trade request from a trader by providing a commit, the commit being an allocation of a portion of the commodities.

15. The business model of claim 13, wherein the trading entity can fulfill the trade request from a trader by providing an open, the open identifying a portion of the commodities but not committing the commodities in case a future trade for the same portion of the commodities is requested.

16. The business model of claim 12, wherein the resource providers are carriers and the commodity is a discrete amount of bandwidth.

17. The business model of claim 16, wherein the trading entity can fulfill the trade request from a trader by providing a commit, the commit being an allocation of a requested amount of bandwidth and connectivity resources required to allow a consuming entity to utilize the bandwidth.

18. The business model of claim 16, wherein the trading entity can fulfill the trade request from a trader by providing an open, the open identifying a portion of bandwidth and the connectivity requirements to allow a consuming entity to utilize the bandwidth but not actually allocating the bandwidth.

19. A business model for trading commodities comprising:
a resource entity, the resource entity being a provider of the commodity; and
a trading entity, the trading entity accumulating commodities from the resource entity and providing a neutral entity from which the trading entity can fulfill a trade request from a trader.

20. The business model of claim 19, wherein the resource entity comprises a plurality of carriers that provide bandwidth and the trading entity can negotiate for the purchase of bandwidth from one or more of the resource providers.

21. The business model of claim 20, wherein the trading entity can fulfill the trade request from a trader by providing a commit, the commit being an allocation of a requested amount of bandwidth and connectivity resources required to allow a consuming entity to utilize the bandwidth.

22. The business model of claim 20, wherein the trading entity can fulfill the trade request from a trader by providing an open, the open identifying a portion of bandwidth and the connectivity requirements to allow a consuming entity to utilize the bandwidth but not actually allocating the bandwidth.
